(19) United States
(12) Patent Application Publication
(10) Pub. No.: US 2012/0297178 A1
(43) Pub. Date: Nov. 22, 2012

(54) CONFIGURATION MODE SWITCHING SYSTEM AND METHOD

(75) Inventors: HAI PENG, Shenzhen City (CN); YUN LOU, Shenzhen City (CN)

(73) Assignees: HON HAI PRECISION INDUSTRY CO., LTD., Tu-Cheng (TW); HONG FU JIN PRECISION INDUSTRY (Shenzhen) CO., LTD., Shenzhen City (CN)

(21) Appl. No.: 13/455,250

(22) Filed: Apr. 25, 2012

(30) Foreign Application Priority Data
May 18, 2011 (CN) 201110129297.8

(51) Int. Cl. G06F 9/00

(52) U.S. Cl. 713/2

(57) ABSTRACT

A computer and method automatically switches from a manufacture mode to a user mode in a basic input and output system (BIOS) chip of the motherboard. The computer invokes an interrupt program to switch from a manufacture mode number to a user mode number in a BIOS setting file. The computer initializes the diagnostic mode according to the parameters of the diagnostic mode and the stress mode according to the parameters of the stress mode. The computer configures the BIOS setting file to a user mode according to the user mode number, and saves configuration into the BIOS chip when the BIOS chip starts.

### BACKGROUND

1. Technical Field

Embodiments of the present disclosure relate to information processing technology, and particularly to a configuration mode switching system and method.

2. Description of Related Art

A motherboard holds many components (e.g., a CPU, a memory, a hard drive) of a personal computer and provides connectors for other peripherals. The motherboard also includes a basic input and output system (BIOS) chip. A BIOS chip may include configuration information of the personal computer. The BIOS chip built in the motherboard includes a manufacture mode and a user mode. The motherboard is tested under the manufacture mode to determine if the motherboard is qualified. After the motherboard is completely finished, the BIOS chip should be configured to the user mode before the motherboard is shipped to a customs. However, at present, the tester manually configures the BIOS chip to the manufacture mode in a menu of the BIOS interface when the motherboard is under a test. After the test is finished, the tester manually configures the BIOS chip to the user mode in a menu of the BIOS interface. This is tedious and time consuming and thus, there is room for improvement in the art.

### BRIEF DESCRIPTION OF THE DRAWINGS

FIG. 1 is a system view of one embodiment of a configuration mode switching system.

FIG. 2 is a block diagram of one embodiment of a computer included in FIG. 1.

FIG. 3 is a flowchart of one embodiment of a configuration mode switching method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

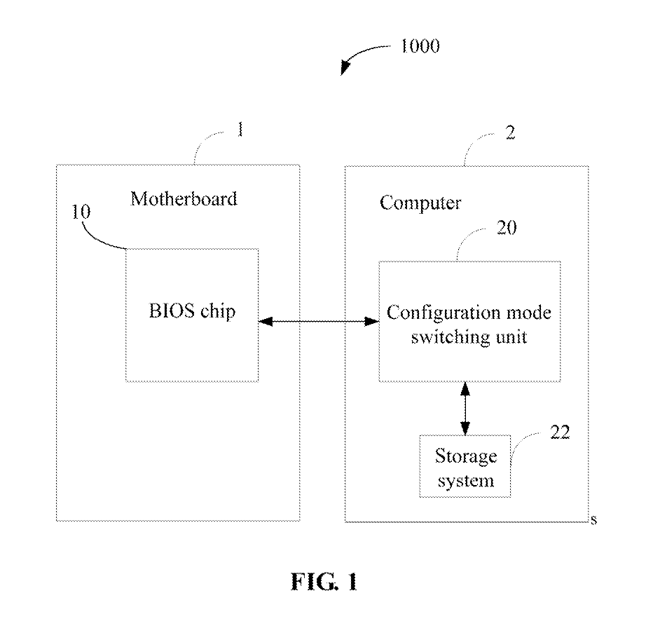

FIG. 1 is a system view of one embodiment of a configuration mode switching system 1000. In one embodiment, the configuration mode switching system 1000 may include a motherboard 1 and a computer 2. The motherboard 1 includes a basic input output system (BIOS) chip 10 and is connected to the computer 2 via an interface, such as a universal serial bus (USB) port.

Depending on the embodiment, the computer 2 includes a configuration mode switching unit 20. Additionally, the computer 2 may be a personal computer (PC), a network server, or any item of other data-processing equipment. Further details of the configuration mode switching unit 20 will be described below.

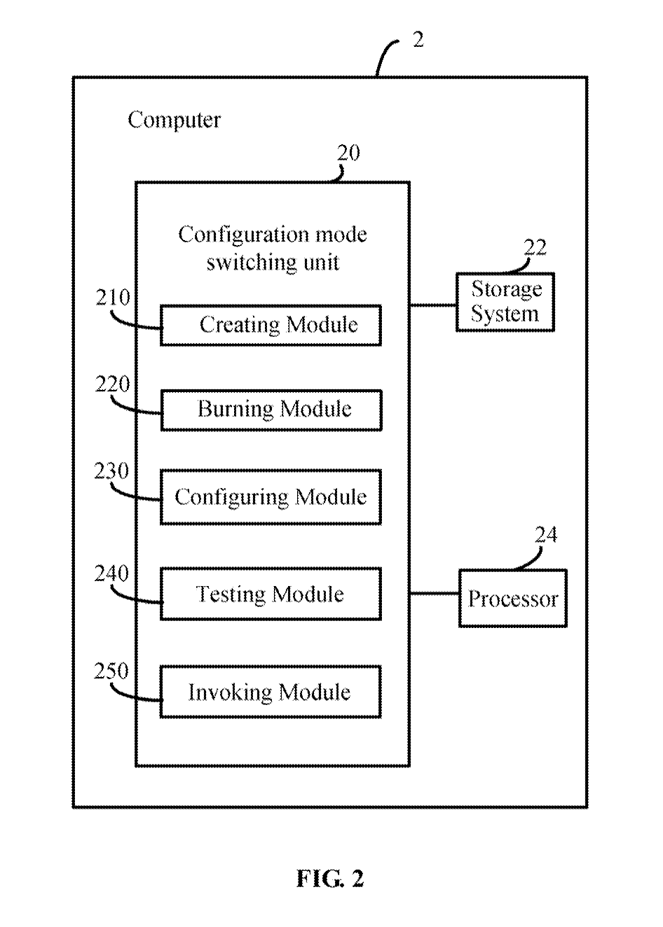

FIG. 2 is a block diagram of one embodiment of the computer 2 included in FIG. 1. In one embodiment, the computer 2 includes a storage system 22, and at least one processor 24. In one embodiment, the configuration mode switching unit 20 further includes a creating module 210, a burning module 220, a configuring module 230, a testing module 240, and invoking module 250. The modules 210-250 may include computerized code in the form of one or more programs that are stored in the storage system 22. The computerized code includes instructions that are executed by the at least one processor 24 to provide functions for modules 210-250. The storage system 22 may be an EPROM memory chip, a flash memory stick, or a hard drive.

The creating module 210 creates a BIOS setting file and sets mode numbers. In one embodiment, the creating module 210 uses a BIOS editing application (e.g., AMI tools BIOS inside V2) to create a BIOS setting file. The BIOS setting file is a BIOS setup menu for the BIOS chip 10. The mode numbers includes a manufacture mode number (e.g., A) and a user mode number (e.g., B). The manufacture mode number corresponds to a manufacture mode. Under the manufacture mode, a first option of COM CONSOLE REDIRECTION in the BIOS setup menu is “enable,” and the first option of BOOT PRIORITY in the BIOS setup menu is “USB HDD.” The motherboard 1 needs to be tested under the manufacture mode before the motherboard 1 is shipped to a user. The user mode number corresponds to a user mode. Under the user mode, the first option of COM CONSOLE REDIRECTION in the BIOS setup menu is “disable,” and the first option of BOOT PRIORITY in the BIOS setup menu is “EUSB HDD.”

The burning module 220 burns the BIOS setting file into the BIOS chip 10. In one embodiment, the BIOS chip 10 can show a BIOS setup menu on a display device of the computer 2 after the BIOS setting file is burned into a memory (e.g., non-volatile random access memory, NVRAM) of the BIOS chip 10.

The configuring module 230 configures the BIOS setting file to the manufacture mode according to the manufacture mode number. In one embodiment, the configuring module 230 reads the manufacture mode number, and configures the first option of the COM CONSOLE REDIRECTION in the BIOS setup menu to “enable,” and configures the first option of the BOOT PRIORITY in the BIOS setup menu to “USB HDD.”

The testing module 240 tests the motherboard 1 under the manufacture mode. The motherboard 1 may be tested by a motherboard application, such as, MOTHERBOARD MONITOR.

The invoking module 250 invokes an interrupt program to switch from a manufacture mode number to the user mode number in the BIOS setting file when the test completes. In one embodiment, the interrupt program may be system management interrupt (SMI). The invoking module 250 invokes the SMI to change the mode number from A to B.

The configuring module 230 configures the BIOS setting file to the user mode according to the user mode number and saving configuration into the BIOS chip 10 when the BIOS chip 10 starts. In one embodiment, the configuring module 230 reads the user mode number, and configures the first option of the COM CONSOLE REDIRECTION in the BIOS setup menu to “disable,” and configures the first option of the BOOT PRIORITY in the BIOS setup menu to “EUSB HDD.”

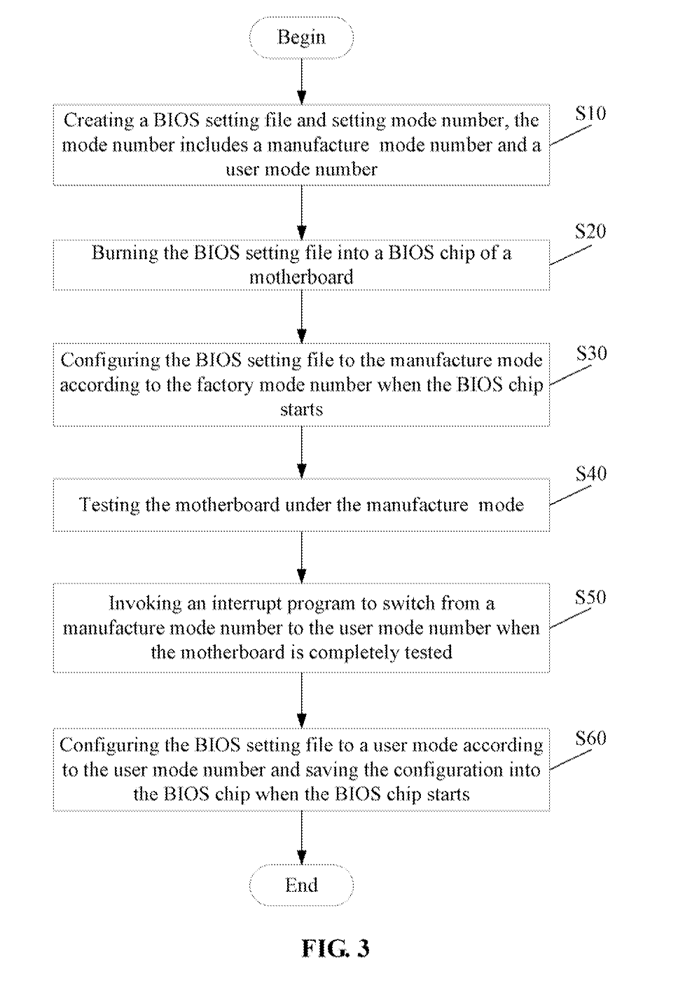

FIG. 3 is a flowchart of one embodiment of a configuration mode switching method. Depending on the embodiment, additional steps may be added, others deleted, and the ordering of the steps may be changed.

In step S10, the creating module 210 creates a BIOS setting file and sets mode numbers for a manufacture mode and a user mode. As mentioned above, the BIOS setting file is a BIOS setup menu for the BIOS chip 10. For example, the manufacture mode number may be A, the user mode number may be B.

In step S20, the burning module 220 burns the BIOS setting file into the BIOS chip 10. In one embodiment, a user can see the BIOS setup menu on a display device of the computer 2 after the BIOS setting file is burned into a memory (e.g., non-volatile random access memory, NVRAM) of the BIOS chip 10.

In step S30, the configuring module 230 configures the BIOS setting file to the manufacture mode according to the manufacture mode number. As mentioned above, the configuring module 230 reads the mode number A from the BIOS setting file, and configures the first option of the COM CONSOLE REDIRECTION in the BIOS setup menu to “enable,” and configures the first option of the BOOT PRIORITY in the BIOS setup menu to “USB HDD.”

In step S40, the testing module 240 tests the motherboard 1 under the manufacture mode. The motherboard 1 may be tested by MOTHERBOARD MONITOR.

In step S50, the invoking module 250 invokes an interrupt program to switch from the manufacture mode number to the user mode number in the BIOS setting file when the test for the motherboard 1 completes. As mentioned above, the invoking module 250 invokes the SMI to change the mode number from A to B.

In step S60, the configuring module 230 configures the BIOS setting file to the user mode according to the user mode number and saving the configuration into the BIOS chip when the BIOS chip starts. In one embodiment, the configuring module 230 reads the mode number B from the BIOS setting file, and configures the first option of the COM CONSOLE REDIRECTION in the BIOS setup menu to “disable,” and configures the first option of the BOOT PRIORITY in the BIOS setup menu to “EUSB HDD.”

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, the computer in electronic communication with a motherboard, the computer comprising:
a storage system;
at least one processor; and
one or more programs including an interrupt program stored in the storage system and being executable by the at least one processor, the one or more programs comprising:
a creating module operable to create a basic input output system (BIOS) setting file and set mode numbers, wherein the mode numbers comprise a manufacture mode number and a user mode number;
a burning module operable to burn the BIOS setting file into a BIOS chip of the motherboard;
a configuring module operable to configure the BIOS setting file to the manufacture mode according to the manufacture mode number;
a testing module operable to test the motherboard under the manufacture mode;
an invoking module operable to invoke the interrupt program to switch from the manufacture mode number to the user mode number in the BIOS setting file when the motherboard has completely tested; and
the configuring module further operable to configure the BIOS setting file to a user mode according to the user mode number, and save configuration into the BIOS chip when the BIOS chip starts.

2. The computer of claim 1, wherein the BIOS setting file is a BIOS setup menu.

3. The computer of claim 2, wherein the manufacture mode is configured as “enable” for a first option of the COM CONSOLE REDIRECTION in the BIOS setup menu and “USB HDD” for the first option of the BOOT PRIORITY in the BIOS setup menu.

4. The computer of claim 2, wherein the user mode is configured as “disable” for the first option of the COM CONSOLE REDIRECTION in the BIOS setup menu and “EUSB HDD” for the first option of the BOOT PRIORITY in the BIOS setup menu.

5. The computer of claim 1, wherein the interrupt program is system management interrupt (SMI).

6. A configuration mode switching method implemented by a computer, the computer in electronic communication with a motherboard, the method comprising:
creating a basic input output system (BIOS) setting file and setting mode numbers, wherein the mode numbers comprises a manufacture mode number and a user mode number;
burning the BIOS setting file into a BIOS chip of the motherboard;
configuring the BIOS setting file to the manufacture mode according to the manufacture mode number;
testing the motherboard under the manufacture mode;
invoking an interrupt program to switch from the manufacture mode number to the user mode number in the BIOS setting file when the motherboard has completely tested, wherein the interrupt program is stored in the computer; and
configuring the BIOS setting file to a user mode according to the user mode number and saving configuration into the BIOS chip when the BIOS chip starts.

7. The method of claim 6, wherein the BIOS setting file is a BIOS setup menu.

8. The method of claim 7, wherein the manufacture mode is configured as “enable” for a first option of the COM CONSOLE REDIRECTION in the BIOS setup menu and “USB HDD” for the first option of the BOOT PRIORITY in the BIOS setup menu.

9. The method of claim 7, wherein the user mode is configured as “disable” for the first option of the COM CONSOLE REDIRECTION in the BIOS setup menu and “EUSB HDD” for the first option of the BOOT PRIORITY in the BIOS setup menu.

10. The method of claim 6, wherein the interrupt program is system management interrupt (SMI).

11. A non-transitory computer-readable medium having stored thereon instructions that, when executed by a computer, the computer in electronic communication with a motherboard, causing the computer to perform a configuration mode switching method, the method comprising:
creating a basic input output system (BIOS) setting file and setting mode numbers, wherein the mode numbers comprises a manufacture mode number and a user mode number;
burning the BIOS setting file into a BIOS chip of the motherboard;
configuring the BIOS setting file to the manufacture mode according to the manufacture mode number;
testing the motherboard under the manufacture mode;
invoking an interrupt program to switch from the manufacture mode number to the user mode number in the BIOS setting file when the motherboard has completely tested, wherein the interrupt program is stored in the computer; and
configuring the BIOS setting file to a user mode according to the user mode number and saving configuration into the BIOS chip when the BIOS chip starts.

12. The medium of claim 11, wherein the BIOS setting file is a BIOS setup menu.

13. The medium of claim 12, wherein the manufacture mode is configured as “enable” for a first option of the COM CONSOLE REDIRECTION in the BIOS setup menu and “USB HDD” for the first option of the BOOT PRIORITY in the BIOS setup menu.

14. The medium of claim 12, wherein the user mode is configured as “disable” for the first option of the COM CONSOLE REDIRECTION in the BIOS setup menu and “EUSB HDD” for the first option of the BOOT PRIORITY in the BIOS setup menu.

15. The medium of claim 11, wherein the interrupt program is system management interrupt (SMI).
